(19) United States
(12) Patent Application Publication
(10) Pub. No.: US 2026/0074440 A1
(43) Pub. Date: Mar. 12, 2026

(54) Electronic Device Antenna with Switchable Resonant Circuit

(71) Applicant: Apple Inc., Cupertino, CA (US)

(72) Inventors: Seyed Mohammad Amjadi, Santa Clara, CA (US); Yiren Wang, Cupertino, CA (US); Sidharath Jain, Redwood City, CA (US); Hao Xu, Cupertino, CA (US); Carlo Di Nallo, Belmont, CA (US); Mattia Pascolini, San Francisco, CA (US); Kodiak D. Burke, Los Gatos, CA (US); Priyank G. Patel, San Diego, CA (US)

(21) Appl. No.: 18/826,927

(22) Filed: Sep. 6, 2024

(51) Int. Cl. H01Q 21/28; H01Q 1/22; H01Q 5/10; H04B 1/04

(52) U.S. Cl. CPC H01Q 21/28; H01Q 1/2208; H01Q 5/10; H04B 1/0483

(57) ABSTRACT

An electronic device may be provided with peripheral sidewalls, a ground, a near-field communications (NFC) transceiver, a non-NFC transceiver, and an antenna that conveys signals for the non-NFC transceiver and the NFC transceiver. The ground may be separated from a segment of the peripheral conductive housing structures by a slot. The non-NFC transceiver may be coupled to a positive antenna feed terminal on the segment. A fixed conductive path may couple a first point on the segment to a second point on the ground. A switchable resonant circuit may couple a third point on the segment to a fourth point on the ground. The switchable resonant circuit may include a switch, an inductor, and a capacitor coupled in series. The positive antenna feed terminal may be interposed on the segment between the first and third points. The NFC transceiver may be coupled to the third point.

### FIELD

This relates generally to electronic devices, including electronic devices with wireless communications capabilities.

### BACKGROUND

Electronic devices such as portable computers and cellular telephones are often provided with wireless communications capabilities and displays. To satisfy consumer demand for small form factor wireless devices, manufacturers are continually striving to implement wireless communications circuitry such as antenna components using compact structures. At the same time, there is a desire for wireless devices to cover a growing number of communications bands. In addition, to optimize user experience, it is often desirable for the viewing area of a display in an electronic device to be as large as possible.

Because antennas have the potential to interfere with each other and with components in a wireless device such as displays, care must be taken when incorporating antennas into an electronic device. Moreover, care must be taken to ensure that the antennas and wireless circuitry in a device are able to exhibit satisfactory performance over a range of operating frequencies and with satisfactory efficiency bandwidth while still allowing the device to exhibit a compact form factor.

### SUMMARY

An electronic device may be provided with wireless circuitry and a housing. The housing may include peripheral conductive housing structures and a ground structure. The wireless circuitry may include an antenna, a near-field communications (NFC) transceiver, and a non-NFC transceiver.

The ground structure may be separated from a segment of the peripheral conductive housing structures by a slot. The peripheral conductive housing structures may have a gap that defines an open end of the slot. The non-NFC transceiver may be coupled to a positive antenna feed terminal on the segment. A fixed conductive path may couple a first point on the segment to a second point on the ground structure. A switchable resonant circuit may be coupled between a third point on the segment and a fourth point on the ground structure. The switchable resonant circuit may include a switch, an inductor, and a capacitor coupled in series between the third and fourth points. The positive antenna feed terminal may be interposed on the segment between the first and third points. The NFC transceiver may be coupled to the third point. The positive antenna feed terminal may form part of a non-NFC feed of the antenna for the non-NFC transceiver. The third point may form part of an NFC feed of the antenna for the NFC transceiver.

### BRIEF DESCRIPTION OF THE DRAWINGS

FIG. 1 is a perspective view of an illustrative electronic device in accordance with some embodiments.

FIG. 2 is a schematic diagram of illustrative circuitry in an electronic device in accordance with some embodiments.

FIG. 3 is a schematic diagram of illustrative wireless circuitry in accordance with some embodiments.

FIG. 4 is a cross-sectional side view of an electronic device having housing structures that may be used in forming antenna structures in accordance with some embodiments.

FIG. 5 is a rear interior view of the upper end of an illustrative electronic device having an antenna with a switchable resonant circuit in accordance with some embodiments.

FIG. 6 is a plot of antenna performance (antenna efficiency) as a function of frequency showing how an illustrative switchable resonant circuit may optimize cellular performance for an illustrative antenna of the type shown in FIG. 5 in accordance with some embodiments.

FIG. 7 is a bar graph of antenna performance (dissipated power) showing how an illustrative switchable resonant circuit may optimize near-field communications performance for an illustrative antenna of the type shown in FIG. 5 in accordance with some embodiments.

### DETAILED DESCRIPTION

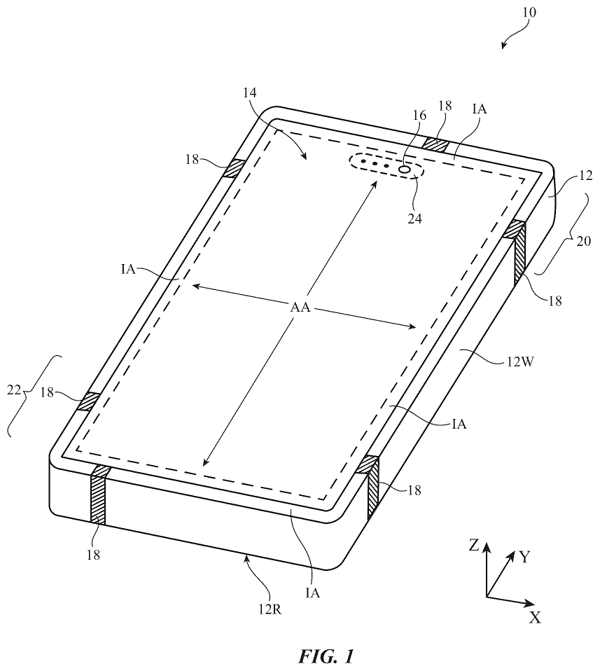

An electronic device such as electronic device 10 of FIG. 1 may be provided with wireless circuitry that includes antennas. The antennas may be used to transmit and/or receive wireless radio-frequency signals.

Device 10 may be a portable electronic device or other suitable electronic device. For example, device 10 may be a laptop computer, a tablet computer, a somewhat smaller device such as a wrist-watch device, pendant device, headphone device, earpiece device, headset device (e.g., virtual, augmented, or mixed reality glasses or goggles), or another wearable or miniature device, a handheld device such as a cellular telephone, a media player, or another small portable device. Device 10 may also be a set-top box, a desktop computer, a display into which a computer or other processing circuitry has been integrated, a display without an integrated computer, a wireless access point, a wireless base station, an electronic device incorporated into a kiosk, building, or vehicle, or other suitable electronic equipment.

Device 10 may include a housing such as housing 12. Housing 12, which may sometimes be referred to as a case, may be formed of plastic, glass, ceramics, fiber composites, metal (e.g., stainless steel, aluminum, etc.), other suitable materials, or a combination of these materials. In some situations, parts of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may, if desired, have a display such as display 14. Display 14 may be mounted on the front face of device 10. Display 14 may be a touch screen that incorporates capacitive touch electrodes or may be insensitive to touch. The rear face of housing 12 (i.e., the face of device 10 opposing the front face of device 10) may have a substantially planar housing wall such as rear housing wall 12R (e.g., a planar housing wall). Rear housing wall 12R may have slots that pass entirely through the rear housing wall and that therefore separate portions of housing 12 from each other. Rear housing wall 12R may include conductive portions and/or dielectric portions. If desired, rear housing wall 12R may include a planar metal layer covered by a thin layer or coating of dielectric such as glass, plastic, sapphire, or ceramic (e.g., a dielectric cover layer). Housing 12 may also have shallow grooves that do not pass entirely through housing 12. The slots and grooves may be filled with plastic or other dielectric materials. If desired, portions of housing 12 that have been separated from each other (e.g., by a through slot) may be joined by internal conductive structures (e.g., sheet metal or other metal members that bridge the slot).

Housing 12 may include peripheral housing structures such as peripheral structures 12W. Conductive portions of peripheral structures 12W and conductive portions of rear housing wall 12R may sometimes be referred to herein collectively as conductive structures of housing 12. Peripheral structures 12W may run around the periphery of device 10 and display 14. In configurations in which device 10 and display 14 have a rectangular shape with four edges, peripheral structures 12W may be implemented using peripheral housing structures that have a rectangular ring shape with four corresponding edges and that extend from rear housing wall 12R to the front face of device 10 (as an example). In other words, device 10 may have a length (e.g., measured parallel to the Y-axis), a width that is less than the length (e.g., measured parallel to the X-axis), and a height (e.g., measured parallel to the Z-axis) that is less than the width. Peripheral structures 12W or part of peripheral structures 12W may serve as a bezel for display 14 (e.g., a cosmetic trim that surrounds all four sides of display 14 and/or that helps hold display 14 to device 10) if desired. Peripheral structures 12W may, if desired, form sidewall structures for device 10 (e.g., by forming a metal band with vertical sidewalls, curved sidewalls, etc.).

Peripheral structures 12W may be formed from a conductive material such as metal and may therefore sometimes be referred to as peripheral conductive housing structures, conductive housing structures, peripheral metal structures, peripheral conductive sidewalls, peripheral conductive sidewall structures, conductive housing sidewalls, peripheral conductive housing sidewalls, sidewalls, sidewall structures, or a peripheral conductive housing member (as examples). Peripheral conductive housing structures 12W may be formed from a metal such as stainless steel, aluminum, alloys, or other suitable materials. One, two, or more than two separate structures may be used in forming peripheral conductive housing structures 12W.

It is not necessary for peripheral conductive housing structures 12W to have a uniform cross-section. For example, the top portion of peripheral conductive housing structures 12W may, if desired, have an inwardly protruding ledge that helps hold display 14 in place. The bottom portion of peripheral conductive housing structures 12W may also have an enlarged lip (e.g., in the plane of the rear surface of device 10). Peripheral conductive housing structures 12W may have substantially straight vertical sidewalls, may have sidewalls that are curved, or may have other suitable shapes. In some configurations (e.g., when peripheral conductive housing structures 12W serve as a bezel for display 14), peripheral conductive housing structures 12W may run around the lip of housing 12 (i.e., peripheral conductive housing structures 12W may cover only the edge of housing 12 that surrounds display 14 and not the rest of the sidewalls of housing 12).

Rear housing wall 12R may lie in a plane that is parallel to display 14. In configurations for device 10 in which some or all of rear housing wall 12R is formed from metal, it may be desirable to form parts of peripheral conductive housing structures 12W as integral portions of the housing structures forming rear housing wall 12R. For example, rear housing wall 12R of device 10 may include a planar metal structure and portions of peripheral conductive housing structures 12W on the sides of housing 12 may be formed as flat or curved vertically extending integral metal portions of the planar metal structure (e.g., housing structures 12R and 12W may be formed from a continuous piece of metal in a unibody configuration). Housing structures such as these may, if desired, be machined from a block of metal and/or may include multiple metal pieces that are assembled together to form housing 12. Rear housing wall 12R may have one or more, two or more, or three or more portions. Peripheral conductive housing structures 12W and/or conductive portions of rear housing wall 12R may form one or more exterior surfaces of device 10 (e.g., surfaces that are visible to a user of device 10) and/or may be implemented using internal structures that do not form exterior surfaces of device 10 (e.g., conductive housing structures that are not visible to a user of device 10 such as conductive structures that are covered with layers such as thin cosmetic layers, protective coatings, and/or other coating/cover layers that may include dielectric materials such as glass, ceramic, plastic, or other structures that form the exterior surfaces of device 10 and/or serve to hide peripheral conductive housing structures 12W and/or conductive portions of rear housing wall 12R from view of the user).

Display 14 may have an array of pixels that form an active area AA that displays images for a user of device 10. For example, active area AA may include an array of display pixels. The array of pixels may be formed from liquid crystal display (LCD) components, an array of electrophoretic pixels, an array of plasma display pixels, an array of organic light-emitting diode display pixels or other light-emitting diode pixels, an array of electrowetting display pixels, or display pixels based on other display technologies. If desired, active area AA may include touch sensors such as touch sensor capacitive electrodes, force sensors, or other sensors for gathering a user input.

Display 14 may have an inactive border region that runs along one or more of the edges of active area AA. Inactive area IA of display 14 may be free of pixels for displaying images and may overlap circuitry and other internal device structures in housing 12. To block these structures from view by a user of device 10, the underside of the display cover layer or other layers in display 14 that overlap inactive area IA may be coated with an opaque masking layer in inactive area IA. The opaque masking layer may have any suitable color.

If desired, the inactive area IA at upper region 20 of device 10 may include an inactive region such as region 24. Region 24 may be laterally surrounded (e.g., on all sides, on four sides, etc.) by active area AA. Region 24 is sometimes also referred to herein as inactive island 24 in display 14. In other implementations, region 24 may be implemented as an inactive notch that is surrounded on three sides by active area AA and that has a fourth edge defined by peripheral conductive housing structures 12W.

Active area AA may be defined by the lateral area of a display module or panel for display 14 (e.g., a display module that includes pixel circuitry, touch sensor circuitry, etc.). Active area AA may display (emit) display light. The display light may contain images (e.g., a video stream of image frames that represent virtual objects, a graphical user interface, video file playback, etc.). The display module may have a recess or notch in upper region 20 of device 10 that is free from active display circuitry (e.g., overlapping region 24). There may, for example, be no active pixels in display 14 within region 24 that emit image for display 14. Region 24 may have a rectangular outline, a circular outline, an elliptical outline, a substantially rectangular outline with rounded edges, or any other desired shape having any desired number of curved and/or straight edges.

Device 10 may include one or more components 16 overlapping and/or aligned with region 24. Component(s) 16 may transmit signals through display 14 and/or may receive signals through display 14. Component(s) 16 may include an image sensor (e.g., a front-facing camera for capturing images through display 14), a phased antenna array (e.g., for conveying millimeter wave signals in a signal beam formed through display 14), an ambient light sensor, one or more infrared emitters (e.g., a dot projector, a flood illuminator, infrared light emitting diodes, etc.) that emit infrared light through display 14, one or more infrared sensors that receive infrared light through display 14, proximity sensors, a speaker, a microphone, and/or any other desired components.

Display 14 may be protected using a display cover layer such as a layer of transparent glass, clear plastic, transparent ceramic, sapphire, or other transparent crystalline material, or other transparent layer(s). The display cover layer may have a planar shape, a convex curved profile, a shape with planar and curved portions, a layout that includes a planar main area surrounded on one or more edges with a portion that is bent out of the plane of the planar main area, or other suitable shapes. The display cover layer may cover the entire front face of device 10. In another suitable arrangement, the display cover layer may cover substantially all of the front face of device 10 or only a portion of the front face of device 10. Openings may be formed in the display cover layer. For example, an opening may be formed in the display cover layer to accommodate a button. An opening may also be formed in the display cover layer to accommodate ports such as a speaker port or a microphone port. Openings may be formed in housing 12 to form communications ports (e.g., an audio jack port, a digital data port, etc.) and/or audio ports for audio components such as a speaker and/or a microphone if desired.

Display 14 may include conductive structures such as an array of capacitive electrodes for a touch sensor, conductive lines for addressing pixels, driver circuits, etc. Housing 12 may include internal conductive structures such as metal frame members and a planar conductive housing member (sometimes referred to as a conductive support plate or backplate) that spans the walls of housing 12 (e.g., a substantially rectangular sheet formed from one or more metal parts that is welded or otherwise connected between opposing sides of peripheral conductive housing structures 12W). The conductive support plate may form an exterior rear surface of device 10 or may be covered by a dielectric cover layer such as a thin cosmetic layer, protective coating, and/or other coatings that may include dielectric materials such as glass, ceramic, plastic, or other structures that form the exterior surfaces of device 10 and/or serve to hide the conductive support plate from view of the user (e.g., the conductive support plate may form part of rear housing wall 12R). Device 10 may also include conductive structures such as printed circuit boards, components mounted on printed circuit boards, and other internal conductive structures. These conductive structures, which may be used in forming a ground plane in device 10, may extend under active area AA of display 14, for example.

In regions 22 and 20, openings may be formed within the conductive structures of device 10 (e.g., between peripheral conductive housing structures 12W and opposing conductive ground structures such as conductive portions of rear housing wall 12R, conductive traces on a printed circuit board, conductive electrical components in display 14, etc.). These openings, which may sometimes be referred to as gaps, may be filled with air, plastic, and/or other dielectrics and may be used in forming slot antenna resonating elements for one or more antennas in device 10, if desired.

Conductive housing structures and other conductive structures in device 10 may serve as a ground plane for the antennas in device 10. The openings in regions 22 and 20 may serve as slots in open or closed slot antennas, may serve as a central dielectric region that is surrounded by a conductive path of materials in a loop antenna, may serve as a space that separates an antenna resonating element such as a strip antenna resonating element or an inverted-F antenna resonating element from the ground plane, may contribute to the performance of a parasitic antenna resonating element, or may otherwise serve as part of antenna structures formed in regions 22 and 20. If desired, the ground plane that is under active area AA of display 14 and/or other metal structures in device 10 may have portions that extend into parts of the ends of device 10 (e.g., the ground may extend towards the dielectric-filled openings in regions 22 and 20), thereby narrowing the slots in regions 22 and 20. Region 22 may sometimes be referred to herein as lower region 22 or lower end 22 of device 10. Region 20 may sometimes be referred to herein as upper region 20 or upper end 20 of device 10.

In general, device 10 may include any suitable number of antennas (e.g., one or more, two or more, three or more, four or more, etc.). The antennas in device 10 may be located at opposing first and second ends of an elongated device housing (e.g., at lower region 22 and/or upper region 20 of device 10 of FIG. 1), along one or more edges of a device housing, in the center of a device housing, in other suitable locations, or in one or more of these locations. The arrangement of FIG. 1 is illustrative and non-limiting.

Portions of peripheral conductive housing structures 12W may be provided with peripheral gap structures. For example, peripheral conductive housing structures 12W may be provided with one or more dielectric-filled gaps such as gaps 18, as shown in FIG. 1. The gaps in peripheral conductive housing structures 12W may be filled with dielectric such as polymer, ceramic, glass, air, other dielectric materials, or combinations of these materials. Gaps 18 may divide peripheral conductive housing structures 12W into one or more peripheral conductive segments. The conductive segments that are formed in this way may form parts of antennas in device 10 if desired. Other dielectric openings may be formed in peripheral conductive housing structures 12W (e.g., dielectric openings other than gaps 18) and may serve as dielectric antenna windows for antennas mounted within the interior of device 10. Antennas within device 10 may be aligned with the dielectric antenna windows for conveying radio-frequency signals through peripheral conductive housing structures 12W. Antennas within device 10 may also be aligned with inactive area IA of display 14 for conveying radio-frequency signals through display 14.

To provide an end user of device 10 with as large of a display as possible (e.g., to maximize an area of the device used for displaying media, running applications, etc.), it may be desirable to increase the amount of area at the front face of device 10 that is covered by active area AA of display 14. Increasing the size of active area AA may reduce the size of inactive area IA within device 10. This may reduce the area behind display 14 that is available for antennas within device 10. For example, active area AA of display 14 may include conductive structures that serve to block radio-frequency signals handled by antennas mounted behind active area AA from radiating through the front face of device 10. It would therefore be desirable to be able to provide antennas that occupy a small amount of space within device 10 (e.g., to allow for as large of a display active area AA as possible) while still allowing the antennas to communicate with wireless equipment external to device 10 with satisfactory efficiency bandwidth.

In a typical scenario, device 10 may have one or more upper antennas and one or more lower antennas. An upper antenna may, for example, be formed in upper region 20 of device 10. A lower antenna may, for example, be formed in lower region 22 of device 10. Additional antennas may be formed along the edges of housing 12 extending between regions 20 and 22 if desired. The antennas may be used separately to cover identical communications bands, overlapping communications bands, or separate communications bands. The antennas may be used to implement an antenna diversity scheme or a multiple-input-multiple-output (MIMO) antenna scheme. Other antennas for covering any other desired frequencies may also be mounted at any desired locations within the interior of device 10. The example of FIG. 1 is illustrative and non-limiting. If desired, housing 12 may have other shapes (e.g., a square shape, cylindrical shape, spherical shape, combinations of these and/or different shapes, etc.).

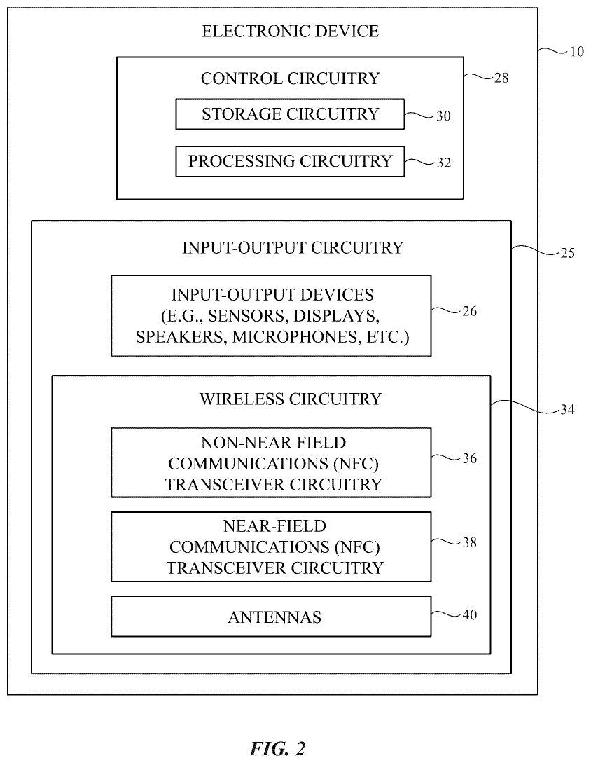

A schematic diagram of illustrative components that may be used in device 10 is shown in FIG. 2. As shown in FIG. 2, device 10 may include control circuitry 28. Control circuitry 28 may include storage such as storage circuitry 30. Storage circuitry 30 may include hard disk drive storage, nonvolatile memory (e.g., flash memory or other electrically-programmable-read-only memory configured to form a solid-state drive), volatile memory (e.g., static or dynamic random-access-memory), etc.

Control circuitry 28 may include processing circuitry such as processing circuitry 32. Processing circuitry 32 may be used to control the operation of device 10. Processing circuitry 32 may include one or more processors such as microprocessors, microcontrollers, digital signal processors, host processors, baseband processor integrated circuits, application specific integrated circuits, graphics processing units, central processing units (CPUs), etc. Control circuitry 28 may be configured to perform operations in device 10 using hardware (e.g., dedicated hardware or circuitry), firmware, and/or software. Software code for performing operations in device 10 may be stored on storage circuitry 30 (e.g., storage circuitry 30 may include non-transitory (tangible) computer readable storage media that stores the software code). The software code may sometimes be referred to as program instructions, software, data, instructions, or code. Software code stored on storage circuitry 30 may be executed by processing circuitry 32.

Control circuitry 28 may be used to run software on device 10 such as internet browsing applications, voice-over-internet-protocol (VOIP) telephone call applications, email applications, media playback applications, operating system functions, etc. To support interactions with external equipment, control circuitry 28 may be used in implementing communications protocols. Communications protocols that may be implemented using control circuitry 28 include internet protocols, wireless local area network protocols (e.g., IEEE 802.11 protocols - sometimes referred to as Wi-Fi®), protocols for other short-range wireless communications links such as the Bluetooth® protocol or other WPAN protocols, IEEE 802.11ad protocols, cellular telephone protocols, MIMO protocols, antenna diversity protocols, satellite navigation system protocols, antenna-based spatial ranging protocols (e.g., radio detection and ranging (RADAR) protocols or other desired range detection protocols for signals conveyed at millimeter and centimeter wave frequencies), etc. Each communication protocol may be associated with a corresponding radio access technology (RAT) that specifies the physical connection methodology used in implementing the protocol.

Device 10 may include input-output circuitry 25. Input-output circuitry 25 may include input-output devices 26. Input-output devices 26 may be used to allow data to be supplied to device 10 and to allow data to be provided from device 10 to external devices. Input-output devices 26 may include user interface devices, data port devices, sensors, and other input-output components. For example, input-output devices 26 may include components 16 of FIG. 1, touch screens, displays without touch sensor capabilities, buttons, joysticks, scrolling wheels, touch pads, key pads, keyboards, microphones, cameras, speakers, status indicators, light sources, audio jacks and other audio port components, digital data port devices, light sensors, gyroscopes, accelerometers or other components that can detect motion and device orientation relative to the Earth, capacitance sensors, proximity sensors (e.g., a capacitive proximity sensor and/or an infrared proximity sensor), magnetic sensors, and other sensors and input-output components. The sensors in input-output devices 26 may include front-facing sensors that gather sensor data through display 14. The front-facing sensors may be optical sensors. The optical sensors may include an image sensor (e.g., a front-facing camera), an infrared sensor, and/or an ambient light sensor. The infrared sensor may include one or more infrared emitters (e.g., a dot projector and a flood illuminator) and/or one or more infrared image sensors.

Input-output circuitry 24 may include wireless circuitry such as wireless circuitry 34 for wirelessly conveying radio-frequency signals. While control circuitry 28 is shown separately from wireless circuitry 34 in the example of FIG. 2 for the sake of clarity, wireless circuitry 34 may include processing circuitry that forms a part of processing circuitry 32 and/or storage circuitry that forms a part of storage circuitry 30 of control circuitry 38 (e.g., portions of control circuitry 28 may be implemented on wireless circuitry 34). As an example, control circuitry 28 may include baseband processor circuitry or other control components that form a part of wireless circuitry 34.

Wireless circuitry 34 may include non-near-field communications (non-NFC) transceiver circuitry 36 (sometimes referred to herein as far-field transceiver circuitry 36). Non-NFC transceiver circuitry 36 may include transceiver circuitry for handling non-NFC communications (e.g., far-field communications using radio-frequency signals conveyed in non-NFC frequency bands). Frequency bands may sometimes be referred to herein as communications bands or simply as “bands”and may span corresponding ranges of frequencies.

The frequency bands handled by non-NFC transceiver circuitry 36 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), a Wi-Fi® 7 band, and/or other Wi-Fi® bands (e.g., from 1875-5160 MHz), wireless personal area network (WPAN) frequency bands such as the 2.4 GHz Bluetooth® band or other WPAN communications bands, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz, or other cellular communications bands between about 600 MHz and about 5000 MHz), 3G bands, 4G LTE bands, 3GPP 5G New Radio Frequency Range 1 (FR1) bands below 10 GHz, 3GPP 5G New Radio (NR) Frequency Range 2 (FR2) bands between 20 and 60 GHz, other centimeter or millimeter wave frequency bands between 10-300 GHz, 3GPP 6G bands (e.g., sub-THz or THz bands from around 100 GHz to around 10 THz), satellite navigation frequency bands such as the Global Positioning System (GPS) L1 band (e.g., at 1575 MHz), L2 band (e.g., at 1228 MHz), L3 band (e.g., at 1381 MHz), L4 band (e.g., at 1380 MHz), and/or L5 band (e.g., at 1176 MHz), a Global Navigation Satellite System (GLONASS) band, a BeiDou Navigation Satellite System (BDS) band, ultra-wideband (UWB) frequency bands that operate under the IEEE 802.15.4 protocol and/or other ultra-wideband communications protocols (e.g., a first UWB communications band at 6.5 GHz and/or a second UWB communications band at 8.0 GHz), communications bands under the family of 3GPP wireless communications standards, communications bands under the IEEE 802.XX family of standards, satellite communications bands such as an L-band, S-band (e.g., from 2-4 GHz), C-band (e.g., from 4-8 GHz), X-band, Ku-band (e.g., from 12-18 GHz), Ka-band (e.g., from 26-40 GHz), etc., industrial, scientific, and medical (ISM) bands such as an ISM band between around 900 MHz and 950 MHz or other ISM bands below or above 1 GHz, one or more unlicensed bands, one or more bands reserved for emergency and/or public services, and/or any other desired frequency bands of interest. Wireless circuitry 34 may also be used to perform spatial ranging operations if desired.

The radio-frequency signals handled by non-NFC transceiver circuitry 36 may propagate in the electromagnetic far-field domain (e.g., over a distance of several feet, several meters, tens of meters, hundreds of meters, thousands of meters, miles, hundreds of miles, etc.). The radio-frequency signals handled by non-NFC transceiver circuitry 36 may sometimes be referred to herein as non-NFC signals or far-field signals.

Wireless circuitry 34 may also include near-field communications (NFC) transceiver circuitry 38 (sometimes referred to herein as NFC circuitry 38, NFC transceiver circuits 38, NFC transceiver 38, near-field circuitry 38, near-field transceiver circuitry 38, or near-field transceiver 38). NFC transceiver circuitry 38 may generate and/or receive radio-frequency signals in an NFC frequency band (e.g., at 13.56 MHz). These radio-frequency signals may sometimes be referred to herein as NFC signals.

The NFC signals may be used to support communications between device 10 and an NFC reader or other external NFC equipment (e.g., an radio-frequency identifier (RFID) device or tag, an RFID reader device, etc.). The NFC signals handled by NFC transceiver circuitry 38 may propagate in the electromagnetic near-field domain (e.g., via electromagnetic near-field coupling over a distance of less than a foot, 20 cm or less, etc.). Near-field communications may, for example, be supported using loop antennas (e.g., to support inductive near-field communications in which a loop antenna in device 10 is electromagnetically near-field coupled to a corresponding loop antenna in an overlapping or adjacent NFC reader). NFC links typically are formed over distances of 20 cm or less (e.g., device 10 must be placed in the vicinity of the near-field communications reader for effective communications).

Non-NFC transceiver circuitry 36 and NFC transceiver circuitry 38 may each include one or more integrated circuits (chips), integrated circuit packages (e.g., multiple integrated circuits mounted on a common printed circuit in a system-in-package device, one or more integrated circuits mounted on different substrates, etc.), power amplifier circuitry, up-conversion circuitry, down-conversion circuitry, low-noise input amplifiers, passive radio-frequency components, switching circuitry, transmission line structures, and other circuitry for handling radio-frequency signals and/or for converting signals between radio-frequencies, intermediate frequencies, and/or baseband frequencies. Non-NFC transceiver circuitry 36 or NFC transceiver circuitry 38 may be omitted from wireless circuitry 34 if desired.

As shown in FIG. 2, wireless circuitry 34 may include antennas 40. Non-NFC transceiver circuitry 36 may convey non-NFC signals at frequencies greater than 100 MHz using one or more antennas 40. NFC transceiver circuitry 38 may convey NFC signals below 100 MHz (e.g., in an NFC frequency band at 13.56 MHz) using one or more antennas 40. If desired, the same antenna 40 may convey non-NFC signals in one or more non-NFC bands and may also convey NFC signals in an NFC band (e.g., concurrently with conveying the non-NFC signals).

In general, transceiver circuitry 36 and 38 may be configured to cover (handle) any suitable frequency bands of interest. The transceiver circuitry may convey radio-frequency signals using antennas 40 (e.g., antennas 40 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antennas 40 may transmit the radio-frequency signals by radiating and/or coupling the radio-frequency signals into free space (or to freespace through intervening device structures such as a dielectric cover layer). Antennas 40 may additionally or alternatively receive the radio-frequency signals from free space (e.g., through intervening devices structures such as a dielectric cover layer). The transmission and reception of radio-frequency signals by antennas 40 each involve the excitation or resonance of antenna currents on an antenna resonating element in the antenna by the radio-frequency signals within the frequency band(s) of operation of the antenna.

Antennas 40 in wireless circuitry 34 may be formed using any suitable antenna types. For example, antennas 40 may include antennas with resonating elements that are formed from stacked patch antenna structures, loop antenna structures, patch antenna structures, inverted-F antenna structures, slot antenna structures, planar inverted-F antenna structures, waveguide structures, monopole antenna structures, dipole antenna structures, helical antenna structures, Yagi (Yagi-Uda) antenna structures, hybrids of these designs, etc. In other implementations, antennas 40 may include antennas with dielectric resonating elements such as dielectric resonator antennas. If desired, one or more of antennas 40 may be cavity-backed antennas. Two or more antennas 40 may be arranged in a phased antenna array if desired (e.g., for conveying centimeter and/or millimeter wave signals). Different types of antennas may be used for different bands and combinations of bands.

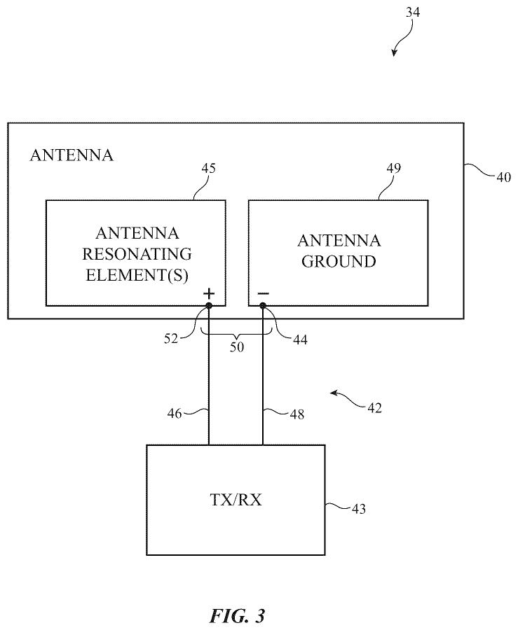

FIG. 3 is a schematic diagram showing how a given antenna 40 may be fed by radio-frequency transceiver (TX/RX) circuitry 43. Radio-frequency transceiver circuitry 43 may include non-NFC transceiver circuitry 36 or NFC transceiver circuitry 38 of FIG. 2. As shown in FIG. 3, antenna 40 may have a corresponding antenna feed 50. Antenna 40 may include one or more antenna resonating (radiating) elements 45 and an antenna ground 49. Antenna resonating element(s) 45 may include one or more radiating arms, slots, waveguides, dielectric resonators, patches, parasitic elements, indirect feed elements, and/or any other desired antenna radiators. Antenna feed 50 may include a positive antenna feed terminal 52 coupled to at least one antenna resonating element 45 and a ground antenna feed terminal 44 coupled to antenna ground 49. If desired, one or more conductive paths (sometimes referred to herein as ground paths, short paths, or return paths) may couple antenna resonating element(s) 45 to antenna ground 49. Antenna ground 49 may be held at a ground potential (e.g., may form part of a system ground for device 10).

Radio-frequency transceiver (TX/RX) circuitry 36 may be coupled to antenna feed 50 using a radio-frequency transmission line path 42 (sometimes referred to herein as transmission line path 42). Transmission line path 42 may include a signal conductor such as signal conductor 46 (e.g., a positive signal conductor). Transmission line path 42 may include a ground conductor such as ground conductor 48. Ground conductor 48 may be coupled to ground antenna feed terminal 44 of antenna feed 50. Signal conductor 46 may be coupled to positive antenna feed terminal 52 of antenna feed 50.

Transmission line path 42 may include one or more radio-frequency transmission lines. The radio-frequency transmission line(s) in transmission line path 42 may include stripline transmission lines (sometimes referred to herein simply as striplines), coaxial cables, coaxial probes realized by metalized vias, microstrip transmission lines, edge-coupled microstrip transmission lines, edge-coupled stripline transmission lines, waveguide structures, combinations of these, etc. Multiple types of radio-frequency transmission line may be used to form transmission line path 42. Filter circuitry, switching circuitry, impedance matching circuitry, phase shifter circuitry, amplifier circuitry, and/or other circuitry may be interposed on transmission line path 42, if desired. One or more antenna tuning components for adjusting the frequency response of antenna 40 in one or more bands may be interposed on transmission line path 42 and/or may be integrated within antenna 40 (e.g., coupled between the antenna ground and the antenna resonating element of antenna 40, coupled between different portions of the antenna resonating element of antenna 40, etc.).

If desired, one or more of the radio-frequency transmission lines in transmission line path 42 may be integrated into ceramic substrates, rigid printed circuit boards, and/or flexible printed circuits. In one suitable arrangement, the radio-frequency transmission lines may be integrated within multilayer laminated structures (e.g., layers of a conductive material such as copper and a dielectric material such as a resin that are laminated together without intervening adhesive) that may be folded or bent in multiple dimensions (e.g., two or three dimensions) and that maintain a bent or folded shape after bending (e.g., the multilayer laminated structures may be folded into a particular three-dimensional shape to route around other device components and may be rigid enough to hold its shape after folding without being held in place by stiffeners or other structures). All the multiple layers of the laminated structures may be batch laminated together (e.g., in a single pressing process) without adhesive (e.g., as opposed to performing multiple pressing processes to laminate multiple layers together with adhesive).

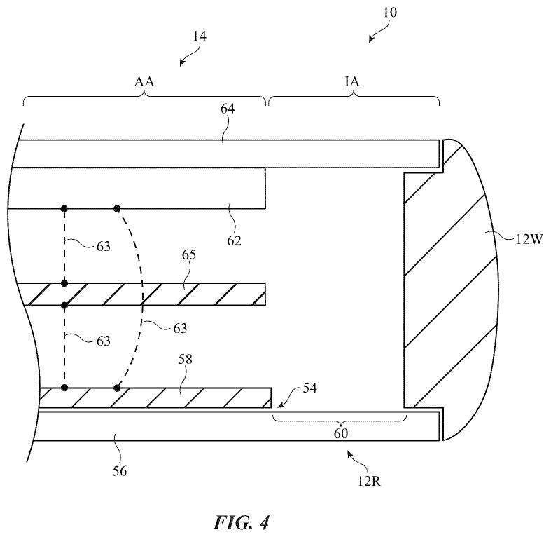

If desired, conductive electronic device structures such as conductive portions of housing 12 (FIG. 1) may be used to form at least part of one or more of the antennas 40 in device 10. FIG. 4 is a cross-sectional side view of device 10, showing illustrative conductive electronic device structures that may be used in forming one or more of the antennas 40 in device 10.

As shown in FIG. 4, peripheral conductive housing structures 12W may extend around the lateral periphery of device 10 (e.g., as measured in the X-Y plane of FIG. 1). Peripheral conductive housing structures 12W may extend from rear housing wall 12R (e.g., at the rear face of device 10) to display 14 (e.g., at the front face of device 10). In other words, peripheral conductive housing structures 12W may form conductive sidewalls for device 10, a first of which is shown in the cross-sectional side view of FIG. 4 (e.g., a given sidewall that runs along an edge of device 10 and that extends across the width or length of device 10).

Display 14 may have a display module such as display module 62 (sometimes also referred to as display panel 62). Display module 62 may include pixel circuitry, touch sensor circuitry, force sensor circuitry, and/or any other desired circuitry for forming active area AA of display 14. Display 14 may include a dielectric cover layer such as display cover layer 64 that overlaps display module 62. Display cover layer 64 may include plastic, glass, sapphire, ceramic, and/or any other desired dielectric materials. Display module 62 may emit image light and may receive sensor input (e.g., touch and/or force sensor input) through display cover layer 64. Display cover layer 64 and display 14 may be mounted to peripheral conductive housing structures 12W. The lateral area of display 14 that does not overlap display module 62 may form inactive area IA of display 14.

As shown in FIG. 4, rear housing wall 12R may be mounted to peripheral conductive housing structures 12W (e.g., opposite display 14). Rear housing wall 12R may include a dielectric cover layer such as dielectric cover layer 56. Dielectric cover layer 56 may include glass, plastic, sapphire, ceramic, one or more dielectric coatings, or other dielectric materials. If desired, conductive material may be layered onto some of the interior lateral surface of dielectric cover layer 56. Dielectric cover layer 56 may extend across an entirety of the width of device 10 and/or an entirety of the length of device 10. If desired, dielectric cover layer 56 may be provided with pigmentation and/or an opaque masking layer (e.g., an ink layer) that helps to hide the interior of device 10 from view.

The housing for device 10 may also include one or more conductive support plates interposed between display 14 and rear housing wall 12R. For example, the housing for device 10 may include a first conductive support plate such as conductive support plate 58 and/or may include a second support plate such as conductive support plate 65. Conductive support plate 58 is vertically interposed between dielectric cover layer 56 and display module 62. Conductive support plate 65 is vertically interposed between conductive support plate 58 and display module 62. Conductive support plate 58 is sometimes also referred to herein as conductive back plate 58, conductive lower chassis 58, lower chassis 58, conductive lower plate 58, lower plate 58, lower interior conductive housing wall 58, conductive layer 58, lower conductive layer 58, or lower conductive support plate 58. Conductive support plate 65 is sometimes also referred to herein as conductive mid-chassis 65, mid-chassis 65, conductive mid-plate 65, mid-plate 65, upper interior conductive housing wall 65, conductive layer 65, upper conductive layer 65, or upper conductive support plate 65.

Conductive support plate 58 may be layered onto dielectric cover layer 56 without adhesive that adheres conductive support plate 58 to dielectric cover layer 56 or may be separated from dielectric cover layer 56 by a non-zero distance (e.g., an air gap). This may, for example, allow dielectric cover layer 56 and/or rear housing wall 12R to be easily removed from device 10 (e.g., to repair and/or replace components within the interior of device 10). Alternatively, conductive support plate 58 may be adhered to dielectric cover layer 56 (e.g., may form a part of rear housing wall 12R). Mid-chassis 65 may be located at a first distance from display 14 whereas conductive support plate 58 is located at a second distance that is greater than the first distance from display 14. If desired, mid-chassis 65 may be omitted from device 10.

Mid-chassis 65 and/or conductive support plate 58 may extend across an entirety of the width of device 10 (e.g., between the left and right edges of device 10 as shown in FIG. 1). Mid-chassis 65 may be formed from an integral portion of peripheral conductive housing structures 12W that extends across the width of device 10 or may include a separate housing structures attached, coupled, or affixed (e.g., welded) to peripheral conductive housing structures 12W. Conductive support plate 58 may, if desired, be formed from a separate conductor than peripheral conductive housing structures 12W (e.g., conductive support plate 58 and peripheral conductive housing structures 12W are not formed from an integral piece of metal) to help facilitate removal of rear housing wall 12R, for example. One or more components may be supported by mid-chassis 65 and/or conductive support plate 58 (e.g., logic boards such as a main logic board, a battery, etc.). Mid-chassis 65 and/or conductive support plate 58 may contribute to the mechanical strength of device 10 (e.g., to prevent external twisting or bending forces from damaging device 10). Mid-chassis 65 and/or conductive support plate 58 may be formed from metal (e.g., stainless steel, aluminum, titanium, etc.).

Conductive support plate 58, mid-chassis 65, and/or display module 62 may have an edge 54 that is separated from peripheral conductive housing structures 12W by dielectric-filled slot 60 (sometimes referred to herein as opening 60, gap 60, or aperture 60). Slot 60 may be filled with air, plastic, ceramic, or other dielectric materials. Conductive housing structures such as conductive support plate 58, mid-chassis 65, conductive portions of display module 62, and/or peripheral conductive housing structures 12W (e.g., the portion of peripheral conductive housing structures 12W opposite conductive support plate 58, mid-chassis 65, and display module 62 at slot 60) may be used to form antenna structures for one or more of the antennas 40 in device 10.

For example, peripheral conductive housing structures 12W may form an antenna resonating element arm (e.g., an inverted-F antenna resonating element arm for non-NFC signals and/or part of a loop path for NFC signals) in the antenna resonating element 45 (FIG. 3) of an antenna 40 in device 10. Mid-chassis 65, conductive support plate 58, and/or display module 62 may be used to form the antenna ground 49 (FIG. 3) for one or more of the antennas 40 in device 10 and/or to form one or more edges of slot antenna resonating elements for the antennas in device 10. One or more conductive interconnect structures 63 may electrically couple mid-chassis 65 to conductive support plate 58, one or more conductive interconnect structures 63 may electrically couple mid-chassis 65 to conductive structures in display module 62 (sometimes referred to herein as conductive display structures), and/or one or more conductive interconnect structures 63 may electrically couple conductive structures in display module 62 to conductive support plate 58 so that each of these elements form part of the antenna ground. The conductive structures in display module 62 may include a conductive frame, bracket, or support plate for display module 62, shielding layers in display module 62, ground traces in display module 62, pixel circuitry, etc.

Conductive interconnect structures 63 may serve to ground mid-chassis 65 to conductive support plate 58 and/or display module 62 (e.g., to ground conductive support plate 58 to the conductive display structures through mid-chassis 65) or may ground display module 62 directly to conductive support plate 58. Put differently, conductive interconnect structures 63 may hold the conductive structures in display module 62, mid-chassis 65, and/or conductive support plate 58 to a common ground or reference potential (e.g., as a system ground for device 10 that is used to form part of antenna ground 49 of FIG. 3). Conductive interconnect structures 63 may therefore sometimes be referred to herein as grounding structures 63, grounding interconnect structures 63, or vertical grounding structures 63. Conductive interconnect structures 63 may include conductive traces, conductive pins, conductive springs (e.g., y-springs or spring fingers), conductive prongs (e.g., conductive blades that mate with conductive spring fingers such as y-springs), conductive brackets, conductive screws, conductive clips, conductive tape, conductive wires, conductive traces, conductive foam, conductive adhesive, solder, welds, metal members (e.g., sheet metal members), contact pads, conductive vias, conductive portions of one or more components mounted to mid-chassis 65 and/or conductive support plate 58, and/or any other desired conductive interconnect structures.

In practice, it may be desirable for an antenna in device 10 to radiate through rear housing wall 12R of device 10 both in a set of non-NFC bands and in an NFC band. However, if care is not taken, the presence of conductive support plate 58, display module 62, and/or other device components can block or undesirably limit the performance of antennas in conveying radio-frequency signals through one or more sides of device 10. In addition, given the increased size of active area AA and the compact form factor of device 10, if care is not taken, the antenna may exhibit insufficient levels of performance in one or more of the non-NFC bands in the set of non-NFC bands and/or in the NFC band. To mitigate these issues while optimizing antenna performance across the set of non-NFC bands and the NFC band, the antenna may include a resonating arm formed from a segment of peripheral conductive housing structures 12W and may include a switchable resonant circuit coupled between the segment and ground.

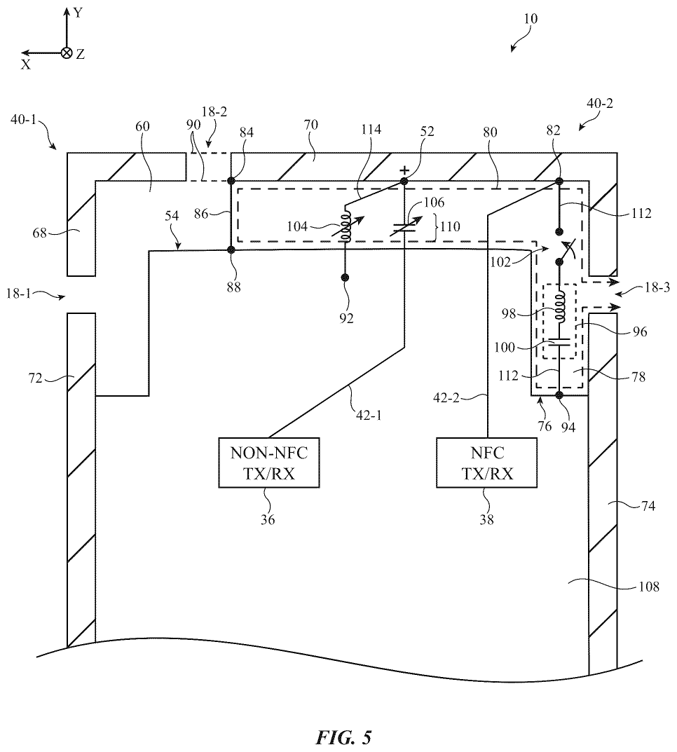

FIG. 5 is a rear interior of device 10 showing one example of an antenna 40-2 in device 10 that may be provided with a resonating arm formed from a segment of peripheral conductive housing structures 12W and that may be provided with a switchable resonant circuit coupled between the segment and ground. In the example of FIG. 5, dielectric cover layer 56 of rear housing wall 12R, mid-chassis 65, display 14, and the internal components of device 10 have been omitted for the sake of clarity.

As shown in FIG. 5, peripheral conductive housing structures 12W may include a first conductive sidewall at the left edge of device 10 (when device 10 is viewed from behind), a second conductive sidewall at the top edge of device 10, a third conductive sidewall at the right edge of device 10 (when device 10 is viewed from behind), and a fourth conductive sidewall at the bottom edge of device 10 (not shown in FIG. 5). Peripheral conductive housing structures 12W may be segmented (divided) by dielectric-filled gaps 18 such as a first gap 18-1, a second gap 18-2, and a third gap 18-3. Gaps 18-1, 18-2, and 18-3 may be filled with plastic, ceramic, sapphire, glass, epoxy, or other dielectric materials. The dielectric material in the gaps may lie flush with peripheral conductive housing structures 12W at the exterior surface of device 10 if desired.

Gap 18-1 may divide the first conductive sidewall to separate segment 72 of peripheral conductive housing structures 12W from segment 68 of peripheral conductive housing structures 12W. Gap 18-2 may divide the second conductive sidewall to separate segment 68 from segment 70 of peripheral conductive housing structures 12W. Gap 18-3 may divide the third conductive sidewall to separate segment 70 from segment 74 of peripheral conductive housing structures 12W. In this example, segment 68 forms the upper-left corner of device 10 when viewed from behind (e.g., segment 68 may have a bend at the corner) and is formed from the first and second conductive sidewalls of peripheral conductive housing structures 12W. Similarly, segment 70 forms the upper-right corner of device 10 when viewed from behind (e.g., segment 70 may have a bend at the corner) and is formed from the second and third conductive sidewalls of peripheral conductive housing structures 12W.

Device 10 may include ground structure 108 extending across the length and width of device 10 (e.g., within the X-Y plane). Ground structure 108 may include conductive support plate 58 (FIG. 4), conductive mid-plate 65 (FIG. 4), conductive portions of display module 64 (FIG. 4), ground traces on one or more printed circuit boards in device 10, and/or other grounded conductive structures in device 10. Ground structure 108 may form the antenna ground of antenna 40-2. Ground structure 108 is sometimes also referred to herein as ground plane 108 or ground 108.

Ground structure 108 may have an upper edge 54 that is separated from segments 68 and 70 of peripheral conductive housing structures 12W by slot 60. Edge 54 may extend across the width of device 10 (e.g., across substantially all of the width of device 10 and substantially parallel to the X-axis). Ground structure 108 may have a right edge that is separated from segments 70 and 74 of peripheral conductive housing structures 12W by a portion of slot 60. Device 10 may have a longitudinal axis that bisects the width of device 10 and that runs parallel to the length of device 10 (e.g., parallel to the Y-axis).

Slot 60 may have a main portion with an elongated shape that extends from at least gap 18-1 or gap 18-2 to gap 18-3 between ground structure 108 and peripheral conductive housing structures 12W (e.g., parallel to the X-axis). If desired, slot 60 may also include an extended portion 78 (sometimes also referred to herein as slot extension 78, slot portion 78, or slot 78) that extends from the main portion of slot 60, towards the lower end of device 10 parallel to the longitudinal axis of device 10 (e.g., the Y-axis), to a closed end 76 of extended portion 78. Extended portion 78 of slot 60 may be laterally interposed between the right edge of ground structure 108 and segments 70 and 74. In the example of FIG. 5, extended portion 78 of slot 60 extends beyond gap 18-3. Alternatively, closed end 76 of extended portion 78 may lie flush with the lower edge of gap 18-3.

Antenna 40-2 may be integrated into slot 60 and peripheral conductive housing structures 12W. Antenna 40-2 may have a first antenna feed that conveys non-NFC signals and may have a second antenna feed that conveys NFC signals. In some implementations, the second antenna feed may be the same as the first antenna feed. The first antenna feed may include a positive antenna feed terminal 52 coupled at a first point on segment 70. In some implementations, antenna 40-2 includes an aperture tuner (e.g., a bank of switchable inductors that can be switched on or off responsive to a control signal to change an impedance of the aperture tuner) that is coupled between a second point 84 on segment 70 and ground structure 108 and that is adjusted to tune a response of antenna 40-2 in a cellular low band. However, aperture tuners such as these can introduce excessive loss and/or can otherwise limit the efficiency of antenna 40-2 in the cellular low band.

Instead of an aperture tuner coupled between points 84 and 88, antenna 40-2 may include a fixed (non-tunable) component such as conductive interconnect structure 86 coupled between point 84 on segment 70 and a first point 88 on ground structure 108. Conductive interconnect structure 86 may, for example, form a fixed (non-tunable and non-adjustable) conductive path from point 84 to point 88.

Point 84 may be located at or adjacent gap 18-2 if desired (e.g., point 84 may be interposed on segment 70 between positive antenna feed terminal 52 and gap 18-2). Conductive interconnect structure 86 may include a conductive spring, a conductive screw, a conductive trace, a conductive wire, a conductive snap, an integral portion of segment 70, solder, welds, conductive adhesive, and/or any other desired conductive interconnect structures. Conductive interconnect structure 86 has a fixed (non-adjustable) inductance that remains constant over time. If desired, conductive interconnect structure 86 may include a fixed inductor having a small, fixed (constant) inductance. Conductive interconnect structure 86 does not receive a control signal, does not change states, and is not adjusted to tune the frequency response of antenna 40-2.

Conductive interconnect structure 86 may form a low impedance path between point 84 and point 88 (e.g., a short circuit path or return path between segment 70 and ground structure 108). In this way, segment 70, conductive interconnect structure 86, ground structure 108, and segment 74 may define a radiating slot such as open slot 80. Open slot 80 may include extended portion 78 of slot 60 and the portion of slot 60 extending from conductive interconnect structure 86 to gap 18-3. Open slot 80 has an open end at gap 18-3. Open slot 80 has a closed end opposite the open end. The closed end of open slot 80 may be defined by conductive interconnect structure 86.

Non-NFC transceiver circuitry 36 may have a signal port coupled to positive antenna feed terminal 52 over transmission line path 42-1. If desired, antenna 40-2 may include a tunable matching circuit 110 coupled to positive antenna feed terminal 52. Tunable matching circuit 110 may include a tunable inductor 104 coupled between positive antenna feed terminal 52 and point 92 on ground structure 108. Point 92 may be interposed on ground structure 108 between point 88 and gap 18-3. Tunable matching circuit 110 may also include a tunable capacitor 106 interposed on the signal conductor of transmission line path 42-1 between non-NFC transceiver circuitry 36 and positive antenna feed terminal 52.

Tunable matching circuit 110 may receive a control signal (not shown) that controls the state of tunable inductor 104 and/or tunable capacitor 106. The control signal may set the inductance of tunable inductor 104 and/or the capacitance of tunable capacitor 106 to configure matching circuit 110 to exhibit a desired impedance (e.g., for performing impedance matching between transmission line path 42-1 and segment 70 at the frequencies of operation of antenna 40-2). Tunable inductor 104 may include a continuously adjustable inductor or a bank of multiple switchable inductors coupled in parallel and/or series between positive antenna feed terminal 52 and point 92. Tunable capacitor 106 may include a continuously adjustable capacitor or a bank of multiple switchable capacitors coupled in parallel and/or series between non-NFC transceiver circuitry 36 and positive antenna feed terminal 52. Non-NFC transceiver circuitry 36 may convey radio-frequency signals in a set of one or more non-NFC bands via transmission line path 42-1, matching circuit 110, and positive antenna feed terminal 52.

Antenna 40-2 may include an additional return path coupled between segment 70 and ground structure 108 such as conductive path 112. Conductive path 112 may couple a third point 82 on segment 70 to a third point 94 on ground structure 108 (e.g., at or adjacent closed end 76 of extended portion 78 of slot 60). Point 82 may be interposed on segment 70 between positive antenna feed terminal 52 and gap 18-3. Point 94 may be interposed on ground structure 108 between point 92 and gap 18-3.

In the example of FIG. 5, antenna 40-2 is configured to convey both non-NFC signals for non-NFC transceiver circuitry 36 and NFC signals for NFC transceiver circuitry 38. Positive antenna feed terminal 52 may form part of a first antenna feed of antenna 40-2 (e.g., a non-NFC feed) that is used by non-NFC transceiver circuitry 36 to feed non-NFC signals for antenna 40-2. NFC transceiver circuitry 38 may be coupled to point 82 on segment 70 over transmission line path 42-2. NFC transceiver circuitry 38 may also be coupled to an additional point (not shown) on segment 78 or ground structure 108 if desired. The additional point and point 82 may form antenna feed terminals of a second antenna feed for antenna 40-2 (e.g., an NFC feed) that is used by NFC transceiver circuitry 38 to feed NFC signals for antenna 40-2.

Antenna 40-2 may include a switchable resonant circuit disposed on conductive path 112 between point 82 on segment 70 and point 94 on ground structure 108. The switchable resonant circuit may include a switch 102 and a resonant circuit 96 coupled in series between switch 102 and point 94 (e.g., switch 102 may be coupled in series between resonant circuit 96 and point 82). Resonant circuit 96 may include an LC resonator having one or more inductors such as inductor 98 and one or more capacitors such as capacitor 100 coupled between switch 102 and point 94. Capacitor 100 may be a fixed capacitor. Inductor 98 may be a fixed inductor. Alternatively, capacitor 100 may be an adjustable (tunable) capacitor and/or inductor 98 may be an adjustable (tunable) inductor. Resonant circuit 96 may have a corresponding resonant frequency given by the capacitance of capacitor 100 and the inductance of inductor 98. Resonant circuit 96 is sometimes also referred to herein as resonator 96, LC resonator 96, resonant LC circuit 96, or resonating circuit 96.

In the example of FIG. 5, inductor 98 is coupled in series with capacitor 100 between switch 102 and point 94. This is illustrative and non-limiting. Alternatively, capacitor 100 may be coupled in parallel with inductor 98 between switch 102 and point 94 (e.g., may be implemented as an LC tank). If desired, capacitor 100 may be coupled in series between inductor 98 and switch 102. In general, resonant circuit 96 may include any desired LC resonator architecture that includes any desired number of capacitors and any desired number of inductors coupled in parallel and/or in series between switch 102 and point 94.

Switch 102 may selectively activate or deactivate resonant circuit 96 over time. Switch 102 may be a single pole single throw (SPST) switch, in a simplest example. In general, switch 102 may be implemented using any desired switch architecture. Switch 102 may be turned on, closed, enabled, or activated (e.g., by asserting a non-zero gate voltage to a transistor in switch 102 causing more than a threshold amount of current to flow between source/drain terminals of the transistor) to activate, enable, or turn on resonant circuit 96. When resonant circuit 96 is active, enabled, or turned on, resonant circuit 96 is coupled in series between point 82 on segment 70 and point 94 on ground structure 108 and contributes to the resonant response of antenna 40-2 in one or more frequency bands.

Conversely, switch 102 may be turned off, opened, disabled, or deactivated (e.g., by deasserting the non-zero gate voltage to the transistor in switch 102, causing less than a threshold amount of current to flow between the source/drain terminals of the transistor) to deactivate resonant circuit 96. When resonant circuit 96 is inactive, disabled, or turned off, resonant circuit 96 is decoupled from point 82 on segment 70, switch 102 forms an open circuit (infinite) impedance between point 82 on segment 70 and point 94 on ground structure 108, and resonant circuit 96 does not contribute to the resonant response of antenna 40-2.

Antenna 40-2 may concurrently convey non-NFC signals for non-NFC transceiver circuitry 36 in one or more non-NFC bands of a set of non-NFC bands covered by antenna 40-2 and. Antenna 40-2 may also concurrently convey NFC signals for NFC transceiver 38. While conveying non-NFC signals, antenna current at frequencies in the set of non-NFC bands flows around the perimeter of open slot 80, through segment 70, conductive interconnect structure 86, and ground structure 108. The antenna current also passes between points 82 and 94 through conductive path 112 and resonant circuit 96 when switch 102 is turned on. Matching circuitry 110 may perform impedance matching in the set of non-NFC bands to minimize signal reflection and loss at positive antenna feed terminal 52. Open slot 80 may form an open slot antenna resonating element and/or segment 70 may form an inverted-F antenna resonating element arm of antenna 40-2 for antenna current in the non-NFC bands. The antenna current may radiate corresponding radio-frequency signals. Conversely, the antenna current may be produced by incident radio-frequency signals received by antenna 40-2.

At the same time, non-NFC transceiver circuitry 38 may use antenna 40-2 to convey NFC signals in an NFC band. While conveying NFC signals, antenna current at frequencies in the NFC band flows around the perimeter of open slot 80, through segment 70, and ground structure 108. However, tunable capacitor 106 and capacitor 100 may form open circuit impedances for antenna current at low frequencies such as frequencies in the NFC band, preventing the antenna current in the NFC band from shorting from segment 70 onto transmission line path 42-1 and preventing the antenna current in the NFC band from shorting from segment 70 onto point 94 of ground structure 108. In this way, segment 70, conductive interconnect structure 86, ground structure 108, and a portion of segment 74 (e.g., the perimeter of open slot 80) may form a loop antenna resonating element in antenna 40-2 that is used to convey NFC signals. If desired, transmission line path 42-2 may include a low pass filter (not shown) to block antenna current in the non-NFC bands from passing onto transmission line path 42-2.

When active, resonant circuit 96 may configure antenna 40-2 to fully support coexistence of each frequency band in the set of non-NFC bands handled by the antenna. For example, resonant circuit 96 may perform impedance matching for a first subset of the set of non-NFC bands (e.g., a cellular midband, a cellular high band, and/or a GPS L1 band) while concurrently forming an open circuit in a second subset of the set of non-NFC bands (e.g., the cellular low band). Antenna current in the first subset of non-NFC bands may pass through resonant circuit 96 (e.g., effectively shortening the resonating length of antenna 40-2 for those bands from gap 18-3 to point 82) whereas antenna current in the second subset of non-NFC bands does not pass through resonant circuit 96 (e.g., antenna 40-2 may have a resonating length from conductive interconnect structure 86 to gap 18-3 for antenna current in the second subset of non-NFC bands).

Resonant circuit 96 may, for example, be turned on when non-NFC transceiver circuitry 36 is using antenna 40-2 to convey non-NFC signals in both the first and second subsets of non-NFC bands (e.g., during midband, low band, and GPS L1 coexistence) and may be turned off when non-NFC transceiver circuitry 36 is not using antenna 40-2 to convey non-NFC signals in both the first and second subsets of non-NFC bands. Alternatively, switch 102 may be omitted and resonant circuit 96 may always contribute to the impedance and response of antenna 40-2.

In this way, resonant circuit 96 may configure antenna 40-2 to convey non-NFC signals in a set of non-NFC bands such as a cellular low band, a cellular midband, and/or a GPS L1 band without impacting the performance of antenna 40-2 in conveying NFC signals for NFC transceiver 38. The absence of aperture tuners in antenna 40-2 for the cellular low band may serve to increase the antenna efficiency of antenna 40-2 in the cellular low band. If desired, device 10 may include an additional antenna 40-1 having an antenna resonating element arm that includes segment 68 of peripheral conductive housing structures 12W. If desired, gap 18-2 may be omitted from peripheral conductive housing structures (as shown by dashed lines 90). In these implementations, conductive interconnect structure 86 may serve to electrically isolate antenna 40-2 from antenna 40-1 or, alternatively, antenna 40-1 may be omitted.

If desired, non-NFC transceiver circuitry 36 and NFC transceiver circuitry 38 may be mounted on a first substrate such as a printed circuit board or main logic board of device 10. If desired, matching circuit 110, switch 102, and resonant circuit 96 may be disposed on a second substrate such as a flexible printed circuit. If desired, matching circuit 110 may be disposed on a first flexible printed circuit whereas switch 102 and resonant circuit 96 are disposed on a second flexible printed circuit. If desired, non-NFC transceiver circuitry 36 and NFC transceiver circuitry 38 may be mounted to separate substrates. Switch 102 and/or resonant circuitry 96 may overlap slot 60 and/or extended portion 78 of slot 60. Alternatively, one or both of switch 102 and resonant circuit 96 may entirely overlap ground structure 108 or may partially overlap slot 60 and ground structure 108.

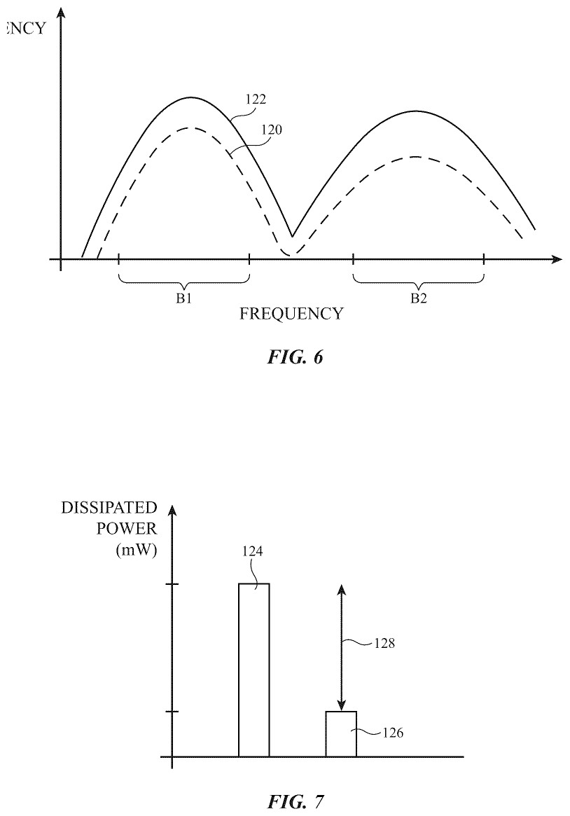

Curve 120 of FIG. 6 plots the antenna efficiency of antenna 40-2 across non-NFC bands B1 and B2 (e.g., two cellular low bands) in implementations where antenna 40-2 includes an aperture tuner coupled between points 84 and 88 and does not include resonant circuit 96.

Curve 122 of FIG. 6 plots the antenna efficiency of antenna 40-2 of FIG. 5 (e.g., where antenna 40-2 includes conductive interconnect structure 86 coupled between points 84 and 88 and includes resonant circuit 96). As shown by curves 120 and 122, the absence of an aperture tuner and the presence of resonant circuit 96 in antenna 40-2 may serve to increase the antenna efficiency of antenna 40-2 across both non-NFC bands B1 and B2. Band B1 may be LTE band B78 and band B2 may be LTE band B8 as one example. Antenna 40-2 may also concurrently cover higher non-NFC bands. Curves 120 and 122 may have other shapes in practice. Non-NFC bands B1 and B2 may contain any desired frequencies.

Block 124 in FIG. 7 plots the dissipated power of antenna 40-2 in the NFC band in implementations where antenna 40-2 includes an aperture tuner coupled between points 84 and 88 and does not include resonant circuit 96. Block 126 in FIG. 7 plots the dissipated power of antenna 40-2 of FIG. 5 (e.g., where antenna 40-2 includes conductive interconnect structure 86 coupled between points 84 and 88 and includes resonant circuit 96). As shown by blocks 124 and 126, the absence of an aperture tuner and the presence of resonant circuit 96 in antenna 40-2 may serve to decrease the dissipated power of antenna 40-2 in the NFC band by margin 128 (e.g., 50-150 mW).

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.” Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is illustrative and various modifications can be made by those skilled in the art without departing from the scope and spirit of the described embodiments. The foregoing embodiments may be implemented individually or in any combination.

What is claimed is:

1. An electronic device comprising:
a ground structure;
peripheral conductive housing structures extending around the ground structure;
a slot that separates a segment of the peripheral conductive housing structures from the ground structure;
a first conductive path that couples a first point on the segment to a second point on the ground structure;
a transmission line path coupled to a positive antenna feed terminal on the segment;
a second conductive path that couples a third point on the segment to a fourth point on the ground structure, the positive antenna feed terminal being interposed on the segment between the first and third points; and
a switchable resonant circuit disposed on the second conductive path.

2. The electronic device of claim 1, further comprising:
a gap that separates the segment of the peripheral conductive housing structures from an additional segment of the peripheral conductive housing structures, wherein the slot comprises an open slot having a closed end and an open end opposite the closed end, the closed end is defined by the first conductive path, and the open end is defined by the gap.

3. The electronic device of claim 2, wherein the third point is interposed on the segment between the positive antenna feed terminal and the gap, the fourth point being interposed on the ground structure between the second point and the gap.

4. The electronic device of claim 3, further comprising:
an additional transmission line path coupled to the segment at the third point.

5. The electronic device of claim 4, further comprising:
a near-field communications (NFC) transceiver coupled to the additional transmission line path and configured to convey first radio-frequency signals associated with first antenna current in an NFC frequency band, wherein the first antenna current flows through the additional transmission line path, the segment, the first conductive path, and the ground structure.

6. The electronic device of claim 5, further comprising:
a non-NFC transceiver coupled to the transmission line path and configured to convey second radio-frequency signals associated with second antenna current in a plurality of non-NFC frequency bands, wherein the second antenna current flows through the transmission line path, the segment, the first conductive path, the second conductive path, and the resonant circuit.

7. The electronic device of claim 6, wherein the resonant circuit comprises:
an inductor;
a switch coupled in series between the inductor and the third point; and
a capacitor coupled in series between the inductor and the fourth point.

8. The electronic device of claim 7, further comprising:
a tunable capacitor disposed on the transmission line path and coupled to the positive antenna feed terminal; and
a tunable inductor coupled between the positive antenna feed terminal and a fifth point on the ground structure, the fifth point being interposed on the ground structure between the second point and the fourth point.

9. The electronic device of claim 8, wherein the first conductive path is non-adjustable.

10. The electronic device of claim 1, wherein the switchable resonant circuit comprises a capacitor and an inductor coupled in series between the third point and the fourth point.

11. The electronic device of claim 10, wherein the switchable resonant circuit further comprises a switch coupled in series between the inductor and the third point.

12. An electronic device comprising:
peripheral conductive housing structures having a gap that divides the peripheral conductive housing structures into first and second segments, the first segment having a bend at a corner of the electronic device;
a display mounted to the peripheral conductive housing structures;
a conductive plate opposite the display;
a slot that separates the conductive plate from the first and second segments;
a conductive interconnect coupling a first point on the first segment to a second point on the conductive plate, the slot having an open end defined by the gap and having an opposing closed end defined by the conductive interconnect; and
an antenna that includes
a positive antenna feed terminal coupled to the first segment, and
an LC resonator coupled between a third point on the first segment and a fourth point on the conductive plate, the third point being interposed on the first segment between the positive antenna feed terminal and the gap, and the positive antenna feed terminal being interposed on the first segment between the first and third points.

13. The electronic device of claim 12, further comprising:
a switch coupled in series between the LC resonator and the third point.

14. The electronic device of claim 12, wherein the LC resonator comprises an inductor and a capacitor coupled in series between the third and fourth points.

15. The electronic device of claim 12, further comprising:
a near-field communications (NFC) transceiver communicatively coupled to the third point; and
a non-NFC transceiver communicatively coupled to the positive antenna feed terminal.

16. The electronic device of claim 15, wherein:
first antenna current flowing through a portion of the first segment between the first and third points, the conductive interconnect, a portion of the conductive plate between the second and third points, and the LC resonator is configured to radiate first radio-frequency signals in a first non-NFC band for the non-NFC transceiver;
second antenna current flowing through the first segment between the conductive interconnect and the gap is configured to radiate second radio-frequency signals in a second non-NFC band for the non-NFC transceiver, the second non-NFC band being lower than the first non-NFC band; and
third antenna current flowing through the first segment, the conductive interconnect, and the conductive plate is configured to wirelessly convey third radio-frequency signals in an NFC band for the NFC transceiver, the LC resonator forming an open circuit in the NFC band and in the second non-NFC band.

17. The electronic device of claim 15, further comprising:
an adjustable capacitor coupled between the non-NFC transceiver and the positive antenna feed terminal; and
an adjustable inductor coupled between the positive antenna feed terminal and a fifth point on the conductive plate, the fifth point being interposed on the conductive plate between the second and fourth points.

18. An antenna comprising:
a ground structure;
a conductive arm;
a fixed conductive path coupling a first point on the conductive arm to a second point on the ground structure;
a switch coupled to a third point on the conductive arm;
an inductor;
a capacitor coupled in series with the inductor between the switch and a fourth point on the ground structure;
a near-field communications (NFC) antenna feed, the third point forming a feed terminal of the NFC feed; and
a non-NFC antenna feed that includes a positive antenna feed terminal interposed on the conductive arm between the first and third points.

19. The antenna of claim 18, further comprising:
an adjustable capacitor coupled between the positive antenna feed terminal and a transmission line path for the non-NFC antenna feed; and
an adjustable inductor coupled between the positive antenna feed terminal and a fifth point on the ground structure, the fifth point being interposed on the ground structure between the second and fourth points.

20. The antenna of claim 19, further comprising:
a slot that separates the conductive arm from the ground structure, wherein the slot has a closed end defined by fixed conductive path, the slot has an open end opposite the closed end, the third point is interposed on the conductive arm between the positive antenna feed terminal and the open end, and the fourth point is interposed on the ground structure between the second point and the open end.
